(19) United States
(12) Patent Application Publication
(10) Pub. No.: US 2010/0072418 A1
(43) Pub. Date: Mar. 25, 2010

(54) Polishing slurry

(75) Inventors: Atsushi Mizutani, Shizuoka (JP); Tooru Yamada, Miyagi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/585,033

(22) Filed: Sep. 1, 2009

(30) Foreign Application Priority Data
Sep. 24, 2008 (JP) 2008-244136

(51) Int. Cl. C09K 13/00

(52) U.S. Cl. 252/79.1

(57) ABSTRACT

A polishing slurry used for chemical mechanical polishing of a barrier layer and an interlayer dielectric film in manufacturing a semiconductor integrated circuit includes two colloidal silicas which have association degrees differing from each other by at least 0.5 and primary particle sizes differing from each other by 5.0 nm or less, an anticorrosive, and an oxidizer. The polishing slurry is used in the barrier metal CMP and is capable of achieving a good polishing rate on the interlayer dielectric film while simultaneously reducing scratching which is a defect on the polished surface.

### CROSS-REFERENCE TO RELATED APPLICATIONS

This application claims priority to Japanese Patent Application No. 2008-244136, filed Sep. 24, 2008, the contents of which are incorporated herein by reference in their entirety. In addition, the entire contents of all patents and references cited in this specification are also incorporated herein by reference.

### BACKGROUND OF THE INVENTION

The present invention relates to a polishing slurry that may be used in the step of manufacturing semiconductor devices. The invention more specifically relates to a polishing slurry that may be advantageously used to polish mainly a barrier layer formed from a metallic barrier material and/or an interlayer dielectric film formed from a material having a low dielectric constant in planarization carried out in the step of forming interconnections in semiconductor devices.

In the development of semiconductor devices typified by semiconductor integrated circuits (hereinafter referred to as “LSI devices”), the trend toward smaller sizes and higher processing speeds has created a need in recent years for higher density and higher integration by the adoption of miniaturization and multilayer constructions of interconnections. Various techniques are being used to this end, including chemical mechanical polishing (hereinafter referred to as “CMP”). CMP is an essential technique for carrying out, for example, the surface planarization of a film to be processed (e.g., an interlayer dielectric film), plug formation, and buried metal interconnect formation. This CMP is used to carry out substrate planarization, to remove surplus metal thin film during the formation of interconnections and to remove surplus barrier layer on the dielectric film.

CMP generally involves attaching a polishing pad onto a circular platen, impregnating the surface of the polishing pad with a polishing slurry, pressing the front side of a substrate (wafer) against the pad, and rotating both the platen and the substrate while applying a predetermined pressure (polishing pressure) from the back side of the substrate so as to planarize the front side of the substrate by the mechanical friction that arises.

In the manufacture of semiconductor devices such as LSIs, fine interconnections are formed in multiple layers. When interconnections of metals such as copper are formed in each layer, films of barrier metals such as Ta, TaN, Ti, TiN, Mn, and Cu—Mn alloys are formed in advance in order to prevent the wiring material from diffusing to the interlayer dielectric film while improving the adhesion of the wiring material.

In order to form each interconnection layer, CMP of a metal film (hereinafter also referred to as “metal film CMP”) is carried out in one stage or multiple stages to remove surplus wiring material deposited by plating or other method. Then, CMP for removing metallic barrier materials (barrier metals) exposed at the surface by the metal film CMP is usually carried out and is hereinafter also referred to as “barrier metal CMP”.

However, since such metallic barrier materials are usually harder than metallic materials for forming interconnections such as copper interconnections, certain undesirable phenomena may arise in CMP. These include dishing, where a soft metal interconnection film is excessively polished to form dish-like hollows which are more deeply polished only at the center portions, instead of providing a planar metal surface after polishing; and erosion, where the dielectric between metal interconnections is polished more than necessary and, in addition, a dish-like depression is formed over the surfaces of a plurality of metal interconnections.

In order to suppress such dishing and erosion, it is required, in the barrier metal CMP following the metal film CMP, to finally form interconnection layers having reduced irregularities due to, for example, dishing and erosion by adjusting the polishing rate in the metal interconnection portions and the polishing rate in the barrier metal portions. In other words, in cases where the barrier metal and the interlayer dielectric film are polished at a relatively lower polishing rate than the metal wiring material in the barrier metal CMP, the interconnection portions are polished more quickly to cause dishing and erosion. It is desirable for the barrier metal and the interlayer dielectric film to be polished at a reasonably high rate in order to prevent these defects. The foregoing dishing very often occurs in the metal film CMP, and the dishing having occurred in the metal film CMP can be reduced by polishing the barrier metal and interlayer dielectric film in the barrier metal CMP at a higher polishing rate than the metal wiring material. Such a high polishing rate will bring about an increased throughput of the barrier metal CMP.

The metal polishing slurry used in CMP typically includes an abrasive (such as alumina or silica) and an oxidizer (such as hydrogen peroxide or persulfuric acid). It is believed that polishing basically takes place with oxidization of the metal surface by the oxidizer and removal of the resulting oxide film by the abrasive.

CMP conducted by using such polishing slurry containing the solid abrasive very often caused scratches due to polishing (scratching), as well as excessive polishing of the entire polishing surface (thinning), dishing, and erosion.

Various studies as described below have been made for such polishing slurry containing a solid abrasive.

Specifically, a CMP polishing slurry and a polishing method for the purpose of polishing at a high rate while hardly causing scratches due to polishing (JP 2003-17446 A), a polishing composition and a polishing method with which the cleaning property was improved in CMP (US 2003/0115806 Al), a polishing composition for preventing polishing abrasive particles from agglomerating (JP 2000-84832 A), and a polishing slurry for the purpose of achieving a high-speed CMP process while reducing erosion and scratching (JP 2008-98652 A) have been proposed.

### SUMMARY OF THE INVENTION

As described above, in the barrier metal CMP, it is desired for the barrier layer and the interlayer dielectric film to be polished at a polishing rate which is equal to or higher than that on the metal interconnection portions. However, the polishing slurries as described in JP 2003-17446 A, US 2003/0115806 Al, JP 2000-84832 A and JP 2008-98652 A could not achieve a high polishing rate and in particular the interlayer dielectric film was not fully polished. In addition, scratching which is a fatal defect on the polished surface has not been fully reduced, nor has a polishing slurry satisfying various requirements been found yet.

In view of the situation as described above, an object of the present invention is to provide a polishing slurry that may be used in the barrier metal CMP to chemically and mechanically polish the barrier layer and the interlayer dielectric film, and particularly a polishing slurry capable of achieving a good polishing rate on the interlayer dielectric film while simultaneously reducing scratching which is a defect on the polished surface.

The inventors of the invention have made an intensive study to solve the foregoing problems and as a result found that these problems can be solved by the use of the polishing slurry described below. The foregoing object has been thus achieved.

(1) A polishing slurry used for chemical mechanical polishing of a barrier layer and an interlayer dielectric film in manufacturing a semiconductor integrated circuit, the polishing slurry comprising two colloidal silicas which have association degrees differing from each other by at least 0.5 and primary particle sizes differing from each other by 5.0 nm or less, an anticorrosive, and an oxidizer.
(2) The polishing slurry of (1), wherein the anticorrosive is an aromatic heterocyclic compound selected from the group consisting of imidazoles, triazoles, tetrazoles, and benzotriazoles.
(3) The polishing slurry of (1) or (2) having a pH of 2 to 6.
(4) The polishing slurry of any one of (1) to (3), further comprising a compound having at least one carboxy group in the molecule.
(5) The polishing slurry of any one of (1) to (4), further comprising a quaternary ammonium salt.

The present invention can provide a polishing slurry that may be used in the barrier metal CMP to chemically and mechanically polish the barrier layer and the interlayer dielectric film, and particularly a polishing slurry capable of achieving a good polishing rate on the interlayer dielectric film while simultaneously reducing scratching which is a defect on the polished surface.

### DETAILED DESCRIPTION OF THE INVENTION

Specific embodiments of the present invention are described below.

The polishing slurry of the invention is one which may be used to chemically and mechanically polish the barrier layer and the interlayer dielectric film in the step of manufacturing semiconductor integrated circuits (and particularly in the step of forming interconnections), and contains two colloidal silicas having different association degrees, an anticorrosive, an oxidizer, and optional ingredients. The two colloidal silicas have association degrees which differ from each other by at least 0.5, and primary particle sizes which differ from each other by 5.0 nm or less.

A single substance or a combination of two or more substances may be used for each ingredient of the polishing slurry of the invention.

Although not clear, the polishing slurry of the invention is presumed to have the following mechanism of action.

To be more specific, the invention can use two colloidal silicas having different association degrees to polish the barrier layer and/or interlayer dielectric film at a high rate which has been unattainable with one colloidal silica. It is believed that abrasives having different association degrees are expected to have different polishing mechanisms, and use of two abrasives having different association degrees enables two polishing mechanisms to be efficiently employed to improve the polishing rate of the barrier layer and/or interlayer dielectric film.

In order to obtain a higher polishing rate with one abrasive, a higher abrasive concentration is necessary, leading to increased scratching after polishing. On the other hand, a polishing slurry using two abrasives of different association degrees requires a lower abrasive concentration in order to polish at a rate equivalent to that in the case of using a polishing slurry containing only one abrasive, thus leading to reduced scratching after polishing.

The “polishing slurry” as used herein encompasses not only polishing slurries actually used for polishing (i.e., optionally diluted polishing slurries) but also polishing concentrates. The concentrates or concentrated polishing slurries refer to those prepared so as to have a higher solute concentration than at the time of use in polishing. Such slurries are diluted with water or an aqueous solution before use in polishing. In the dilution, the concentrate is typically diluted to 1 to 20 volumes. In the practice of the invention, the terms “concentration” and “concentrate” are used in the sense customarily used in the art, namely, when the solution is more “concentrated” or the solution is a “concentrate” having a higher concentration than the polishing slurry actually used in polishing. In other words, these terms are not used in the general sense involving the physical concentration procedure such as evaporation.

The respective ingredients making up the polishing slurry of the invention are described below in detail.

[Colloidal Silica]

The polishing slurry of the invention contains, as at least part of the abrasive particles, two colloidal silicas having association degrees which differ from each other by at least 0.5 and also having primary particle sizes which differ from each other by 5.0 nm or less. A high polishing rate and a high scratch resistance are achieved by using two colloidal silicas of different association degrees.

Typical techniques for producing colloidal silica include a sol-gel process and a water glass process. It is possible to obtain a beneficial effect even with colloidal silica produced by these processes. Any known method may be used for its production. Commercially available products may also be used.

The sol-gel process is a process in which an alkoxysilane such as tetraethoxysilane is used as a starting material and particles are grown by a condensation reaction in water containing a water-soluble organic solvent such as alcohol. The water glass process is a process in which an alkali metal silicate such as sodium silicate is used as a starting material and particles are grown by a condensation reaction in an aqueous solution.

The primary particle size (diameter) R of the colloidal silicas that may be used in the invention is selected as appropriate for the intended purpose of the abrasive used. The primary particle size is generally from about 10 to about 200 nm, but in terms of the capability to further suppress scratches due to polishing, is preferably from 10 to 100 nm and more preferably from 10 to 50 nm.

The primary particle size R is calculated based on the specific surface area S and the specific gravity d of the colloidal silica measured by the BET method (calculating formula R=6/dS).

The association degree of the colloidal silicas that may be used in the invention is selected as appropriate for the intended purpose of the abrasive used, but is preferably from 1 to 5 and more preferably from 1 to 3 in terms of the capability to achieve a high polishing rate and a high scratch resistance.

The association degree refers to a value obtained by dividing the diameter of secondary particles in the form of agglomerated primary particles by the diameter of the primary particles (the diameter of the secondary particles/the diameter of the primary particles). More specifically, the association degree is determined by dividing the average particle size (secondary particle size) of colloidal silica dispersed in pure water as measured by dynamic light scattering by the primary particle size obtained as described above. Accordingly, when the abrasive has an association degree of 1, the abrasive solely comprises monodispersed primary particles. The average particle size can be measured by dynamic light scattering using an apparatus typified by LB-500 (manufactured by Horiba, Ltd.).

As described above, the polishing slurry of the invention contains two colloidal silicas of different association degrees (which are hereinafter referred to as “colloidal silica (A)” and “colloidal silica (B)”, respectively). In the practice of the invention, the colloidal silicas (A) and (B) have association degrees which differ from each other by at least 0.5, and in terms of achieving a higher polishing rate, preferably at least 1 and more preferably 1 to 4.

The colloidal silicas (A) and (B) have primary particle sizes which differ from each other by 5.0 nm or less and preferably 3.0 nm or less. The lower limit is desirably as small as possible and preferably 0. At a large primary particle size difference, particles having a larger primary particle size have greater effect on both of the polishing rate and scratching after polishing, and the effects of the invention are not readily achieved.

The total content of the colloidal silicas in the polishing slurry of the invention is preferably 0.1 to 30 wt % and more preferably 0.5 to 15 wt % with respect to the weight of the polishing slurry at the time of use in polishing (i.e., diluted polishing slurry in the case of diluting with water or an aqueous solution; the “polishing slurry at the time of use in polishing” to be described later has the same meaning). In other words, the colloidal silicas are preferably incorporated in an amount of at least 0.1 wt % in terms of polishing the barrier layer and/or interlayer dielectric film at a high enough polishing rate and in an amount of not more than 30 wt % in terms of storage stability.

The two colloidal silicas of different association degrees that may be used in the polishing slurry of the invention (i.e., colloidal silica (A) and colloidal silica (B)) are mixed in a weight ratio of 9/1 to 1/9 and more preferably 2/8 to 8/2 in terms of achieving a high polishing rate and a high scratch resistance.

The effects of the invention can be fully achieved by using two colloidal silicas of different association degrees, but the polishing slurry may optionally contain three or more colloidal silicas of different association degrees.

### [Anticorrosive]

The polishing slurry of the invention contains an anticorrosive which adsorbs onto the polished surface to form a film thereby controlling the corrosion of the metal surface. The polishing slurry of the invention preferably includes, as the anticorrosive, an aromatic heterocyclic compound which contains at least three nitrogen atoms in the molecule and has a fused ring structure. The “at least three nitrogen atoms” are preferably atoms making up a fused ring. The aromatic heterocyclic compound may have functional groups such as carboxy group, sulfo group, hydroxy group and alkoxy group.

Examples of such aromatic heterocyclic compound include imidazoles, triazoles, tetrazoles, and benzotriazoles. Benzotriazoles, and their derivatives having various substituents introduced therein are preferably used.

Examples of the anticorrosive that may be used in the invention include 1,2,3-benzotriazole, 5,6-dimethyl-1,2,3-benzotriazole, 1-(1,2-dicarboxyethyl)benzotriazole, 1-[N,N-bis(hydroxyethyl)aminomethyl]benzotriazole, 1-(hydroxymethyl)benzotriazole, tolyltriazole, 1H-tetrazole, 5-aminotetrazole, 1H-tetrazole-5-acetic acid, imidazole, 1-(1,2-dicarboxyethyl)tolyltriazole, 1-[N,N-bis(hydroxyethyl)aminomethyl]tolyltriazole.

Of these, the anticorrosive is more preferably selected from among 1,2,3-benzotriazole, 5,6-dimethyl-1,2,3-benzotriazole, 1-(1,2-dicarboxyethyl)benzotriazole, 1-[N,N-bis(hydroxyethyl)aminomethyl]benzotriazole, and 1-(hydroxymethyl)benzotriazole.

The content of the anticorrosive in the polishing slurry of the invention is preferably 0.01 to 0.2 wt % and more preferably 0.03 to 0.2 wt % with respect to the weight of the polishing slurry at the time of use in polishing. In other words, the anticorrosive content is preferably at least 0.01 wt % in terms of preventing dishing from being enlarged but preferably not more than 0.2 wt % in terms of storage stability.

[Oxidizer]

The polishing slurry of the invention contains a compound (oxidizer) which is capable of oxidizing the metal to be polished.

Illustrative examples of the oxidizer include hydrogen peroxide, peroxides, nitrates, iodates, periodates, hypochlorites, chlorites, chlorates, perchlorates, persulfates, bichromates, permanganates, ozonated water, silver (II) salts, and iron (III) salts. Of these, hydrogen peroxide is particularly preferred.

Preferred exemplary iron (III) salts include inorganic iron (III) salts such as iron (III) nitrate, iron (III) chloride, iron (III) sulfate and iron (III) bromide, and also organic complex salts of iron (III).

The content of the oxidizer in the polishing slurry of the invention can be adjusted by the initial dishing amount in the barrier CMP. In cases where the initial dishing amount in the barrier CMP is large, in other words, the wiring material is not to be polished so much in the barrier CMP, the oxidizer is preferably used in the polishing slurry in a smaller amount. In cases where the dishing amount is sufficiently small to polish the wiring material at a high speed, the oxidizer is preferably used in the polishing slurry in a larger amount. It is thus desirable to change the amount of oxidizer added depending on the initial state of dishing in the barrier CMP. In particular, the oxidizer is preferably incorporated in an amount of 0.01 to 1.0 mol and more preferably 0.05 to 0.6 mol per liter of the polishing slurry at the time of use in polishing.

[Other Ingredients]

In addition to the ingredients described above, the polishing slurry of the invention may contain other ingredients such as a carboxy group-containing compound (organic acid), a quaternary ammonium salt, a surfactant, a pH adjuster, and a water softener as long as the effects of the invention are not impaired.

[Carboxy Group-Containing Compound (Organic Acid)]

The polishing slurry of the invention may contain a carboxy group-containing compound (organic acid). The carboxyl group-containing organic acid (organic acid) is used without particular limitation as long as it is a compound containing at least one carboxy group in the molecule, and examples thereof include amino acids such as glycine and α-alanine. In terms of improving the polishing rate, it is preferable to select a compound represented by general formula (I) indicated below.

The number of carboxy groups in the molecule is preferably from 1 to 4, and more preferably from 1 to 2 because they can be used at a low cost.

R^{a}—O—R^{b}—COOH General formula (I)

In general formula (I), R^{a} and R^{b} each independently represent a hydrocarbon group or an oxygen-containing hydrocarbon group, provided that R^{a} and R^{b} may be bonded together to form a cyclic structure.

R^{a} represents a monovalent hydrocarbon group (aliphatic hydrocarbon group or aromatic hydrocarbon group) or oxygen-containing hydrocarbon group, and a monovalent hydrocarbon group or oxygen-containing hydrocarbon group having 1 to 10 carbon atoms is preferable. Illustrative examples that may be preferably used include alkyl groups having 1 to 10 carbon atoms such as methyl group and cycloalkyl groups; aryl groups such as phenyl group; alkoxy groups and aryloxy groups.

R^{b} represents a divalent hydrocarbon group or oxygen-containing hydrocarbon group, and a divalent hydrocarbon group or oxygen-containing hydrocarbon group having 1 to 10 carbon atoms is preferable. Illustrative examples that may be preferably used include alkylene groups having 1 to 10 carbon atoms such as methylene group and cycloalkylene groups; arylene groups such as phenylene group; and alkyleneoxy groups.

The hydrocarbon group and oxygen-containing hydrocarbon group represented by R^{a} and R^{b}, respectively, may further have a substituent. Examples of the substituent that can be introduced include alkyl groups having 1 to 3 carbon atoms, aryl groups, alkoxy groups and carboxy group. In cases where the hydrocarbon group or oxygen-containing hydrocarbon group is substituted with a carboxy group, this compound has a plurality of carboxy groups.

R^{a} and R^{b} may be bonded together to form a cyclic structure. The cyclic structure formed is not particularly limited and examples thereof include 5- to 6-membered cyclic structures containing the oxygen atom (O) in general formula (I). The cyclic structure may be aromatic or nonaromatic and is preferably composed of an atomic group including the oxygen atom in general formula (I) and carbon atom.

Examples of the carboxy group-containing compound (organic acid) in the invention include 2,5-furandicarboxylic acid, 2-tetrahydrofurancarboxylic acid, methoxycarboxylic acid, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, as well as ammonium salts and alkali metal salts thereof, and mixtures thereof.

Of these, formic acid, malonic acid, malic acid, tartaric acid, and citric acid may be advantageously used in the laminate film containing a layer made of at least one metal selected from copper, copper alloys, and oxides of copper and copper alloys.

Another preferable example of the carboxy group-containing compound (organic acid) includes an amino acid. The amino acid is preferably water-soluble and is more suitably selected from, for example, the following group including glycine, L-alanine, β-alanine, L-2-aminobutyric acid, L-norvaline, L-valine, L-leucine, L-norleucine, L-isoleucine, L-alloisoleucine, L-phenylalanine, L-proline, sarcosine, L-ornithine, L-lysine, taurine, L-serine, L-threonine, L-allothreonine, L-homoserine, L-tyrosine, 3,5-diiodo-L-tyrosine, β-(3,4-dihydroxyphenyl)-L-alanine, L-thyroxine, 4-hydroxy-L-proline, L-cysteine, L-methionine, L-ethionine, L-lanthionine, L-cystathionine, L-cystine, L-cysteic acid, L-aspartic acid, L-glutamic acid, S-(carboxymethyl)-L-cysteine, 4-aminobutyric acid, L-asparagine, L-glutamine, azaserine, L-arginine, L-canavanine, L-citrulline, δ-hydroxy-L-lysine, creatine, L-kynurenine, L-histidine, 1-methyl-L-histidine, 3-methyl-L-histidine, ergothioneine, L-tryptophan, actinomycin Cl, apamin, angiotensin I, angiotensin II, and antipain.

Of the above-described carboxy group-containing organic acids, malic acid, tartaric acid, citric acid, glycine, and glycolic acid are particularly preferred in terms of effectively suppressing the etching rate while maintaining practically acceptable CMP rate.

The content of the carboxy group-containing compound (preferably the compound represented by general formula (I)) in the polishing slurry of the invention is preferably 0.1 to 5.0 wt % and more preferably 0.1 to 2.0 wt % with respect to the weight of the polishing slurry at the time of use in polishing. In other words, the content of the carboxy group-containing compound (organic acid) is preferably at least 0.1 wt % in terms of achieving a high enough polishing rate but preferably not more than 5.0 wt % in terms of preventing excessive dishing from occurring.

[Quaternary Ammonium Salt]

The polishing slurry of the invention may contain a quaternary ammonium salt (hereinafter often referred to simply as “specific cation salt”).

The quaternary ammonium salt of the invention is not particularly limited as long as it is a salt containing quaternary nitrogen in the molecular structure, but is preferably of a structure containing one or two quaternary nitrogens in the molecular structure. In terms of significantly improving the polishing rate, the quaternary ammonium salt is preferably one represented by general formula (II) or general formula (III):

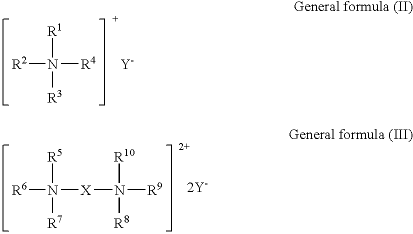

In general formula (II), R¹ to R⁴ each independently represent an alkyl group having 1 to 20 carbon atoms, an alkenyl group, a cycloalkyl group, an aryl group or an aralkyl group, Y⁻ represents an anion, provided that any two of R¹ to R⁴ may be bonded together to form a cyclic structure.

In general formula (III), R⁵ to R¹⁰ each independently represent an alkyl group having 1 to 20 carbon atoms, an alkenyl group, a cycloalkyl group, an aryl group or an aralkyl group, X represents an alkylene group having 1 to 20 carbon atoms, an alkenylene group, a cycloalkylene group, an arylene group or a combination of two or more thereof. Y⁻ represents an anion, provided that any two of R⁵ to R¹⁰ may be bonded together to form a cyclic structure.

In general formula (II), R¹ to R⁴ each independently represent an alkyl group having 1 to 20 carbon atoms, an alkenyl group, a cycloalkyl group, an aryl group or an aralkyl group.

Examples of the alkyl group having 1 to 20 carbon atoms that may be preferably used include those having 1 to 12 alkyl groups and more preferably those having 1 to 6 carbon atoms. Specific examples include methyl group, ethyl group, propyl group, butyl group, pentyl group, hexyl group, heptyl group and octyl group. Of these, methyl group, ethyl group, propyl group and butyl group are preferred.

The alkenyl group preferably contains 2 to 10 carbon atoms and specific examples thereof include ethynyl group and propynyl group.

The cycloalkyl group preferably contains 5 to 6 carbon atoms and specific examples thereof include cyclohexyl group and cyclopentyl group. Of these, cyclohexyl group is preferred.

The aryl group preferably contains 6 to 10 carbon atoms and specific examples thereof include phenyl group and naphthyl group. Of these, phenyl group is preferred.

The aralkyl group preferably contains 7 to 10 carbon atoms and specific examples thereof include benzyl group.

Any two of R¹ to R⁴ may be bonded together to form a cyclic structure. The cyclic structure is not particularly limited and is preferably a 5- or 6-membered cyclic structure containing the nitrogen atom in general formula (II).

The groups represented by R¹ to R⁴, respectively, may further have a substituent. Examples of the substituent that may be introduced include hydroxy group, amino group, carboxy group, heterocyclic group, pyridinium group, aminoalkyl group, phosphate group, imino group, thiol group, sulfo group and nitro group.

In general formula (II), Y represents an anion. Specific examples thereof include hydroxide ion, halide ions (fluorine ion, chlorine ion, bromine ion and iodine ion), nitrate ion, nitrite ion, and acetate ion.

In general formula (III), R⁵ to R¹⁰ each independently represent an alkyl group having 1 to 20 carbon atoms, an alkenyl group, a cycloalkyl group, an aryl group or an aralkyl group. The respective groups represented by R⁵ to R¹⁰ are as defined above for the groups represented by R¹ to R⁴ in general formula (II), and the preferable range is also the same.

Any two of R⁵ to R¹⁰ may be bonded together to form a cyclic structure. The cyclic structure is not particularly limited.

In general formula (III), Y⁻ represents an anion and is as defined above for Y⁻ in general formula (II).

In general formula (III), X represents a linking group, and specifically represents an alkylene group having 1 to 20 carbon atoms, an alkenylene group, a cycloalkylene group, an arylene group or a combination of two or more thereof. In addition to the above-described linking groups, the linking group represented by X may also contain —S—, —S(═O)₂—, —O—, or —C(═O)— in the chain.

Examples of the alkylene group having 1 to 20 carbon atoms that may be more preferably used include those having 1 to 12 carbon atoms. Specific examples thereof include methylene group, ethylene group, propylene group, butylene group, pentylene group, hexylene group, heptylene group and octylene group. Of these, ethylene group and pentylene group are preferred.

The alkenylene group preferably contains 2 to 6 carbon atoms. Specific examples thereof include ethynylene group and propynylene group. Of these, propynylene group is preferred.

The cycloalkylene group preferably contains 5 to 6 carbon atoms. Specific examples thereof include cyclohexylene group and cyclopentylene group. Of these, cyclohexylene group is preferred.

The arylene group preferably contains 6 to 12 carbon atoms. Specific examples thereof include phenylene group and naphthylene group. Of these, phenylene group is preferred.

The respective linking groups represented by X may further have a substituent. Examples of the substituent that may be introduced include hydroxy group, amino group, sulfonyl group, carboxy group, heterocyclic group, pyridinium group, aminoalkyl group, phosphate group, imino group, thiol group, sulfo group and nitro group.

Illustrative examples of the quaternary ammonium salt include tetramethylammonium nitrate, tetraethylammonium nitrate, tetrapropylammonium nitrate, tetraisopropylammonium nitrate, tetracyclopropylammonium nitrate, tetrabutylammonium nitrate, tetraisobutylammonium nitrate, tetra-tert-butylammonium nitrate, tetra-sec-butylammonium nitrate, trimethylbenzylammonium nitrate, lauryltrimethylammonium nitrate, tetrapentylammonium nitrate, hexamethoniumammonium nitrate, hexaethoniumammonium nitrate, hexapropiniumammonium nitrate, and hexabutoniumammonium nitrate. The counter anion of these illustrated compounds is not limited to nitrate ion but may be hydroxide ion, chlorine ion or bromine ion.

The content of the quaternary ammonium salt in the polishing slurry of the invention is preferably 0.0001 to 1.0 wt % and more preferably 0.001 to 0.3 wt % with respect to the weight of the polishing slurry at the time of use in polishing. In other words, the quaternary ammonium salt content is preferably at least 0.0001 wt % in terms of significantly improving the polishing rate but preferably not more than 1.0 wt % in terms of sufficiently high slurry stability.

[Surfactant]

The polishing slurry of the invention including any of various surfactants enables the polishing rates of the interlayer dielectric film and barrier layer to be more easily adjusted.

The surfactant used may be a cationic surfactant, a nonionic surfactant or an anionic surfactant, but a surfactant having ethylene oxide group or sulfo group easily has a greater effect.

The total content of the surfactants in the polishing slurry of the invention is preferably 0.001 to 10 g, more preferably 0.01 to 5.0 g and most preferably 0.01 to 1.0 g per liter of the polishing slurry at the time of use in polishing. In other words, the surfactant content is preferably at least 0.001 g in terms of achieving a beneficial effect but preferably not more than 10 g in terms of preventing the CMP rate from lowering.

[pH Adjuster]

The polishing slurry of the invention preferably has a pH of 2.0 to 6.0. By controlling the pH of the polishing slurry within the above-defined range, the polishing rates of the interlayer dielectric film and the barrier layer can be more easily adjusted while simultaneously achieving a high polishing rate and a high scratch resistance at a higher level.

An alkali/acid or a buffering agent is used to adjust the pH within the above-defined preferable range.

Examples of the alkali/acid and the buffering agent include nonmetallic alkaline agents such as ammonia, organic ammonium hydroxides (e.g., tetramethylammonium hydroxide, ammonium hydroxide), and alkanolamines (e.g., diethanolamine, triethanolamine, and triisopropanol amine); alkali metal hydroxides such as sodium hydroxide, potassium hydroxide, and lithium hydroxide; inorganic acids such as nitric acid, sulfuric acid and phosphoric acid; carbonates such as sodium carbonate; phosphates such as trisodium phosphate; borates; tetraborates; and hydroxybenzoates.

Ammonium hydroxide, potassium hydroxide, lithium hydroxide, and tetramethylammonium hydroxide are particularly preferred alkaline agents.

The alkali/acid or buffering agent should be added to the polishing slurry of the invention in such an amount that the pH is maintained in a preferable range, and the content is preferably from 0.0001 to 1.0 mol, and more preferably from 0.003 to 0.5 mol, per liter of the polishing slurry at the time of use in polishing.

[Water Softener]

It is preferable for the polishing slurry of the invention to optionally contain a water softener (i.e., chelating agent) to reduce an adverse effect of polyvalent metal ion contaminants.

Illustrative examples of the water softener include general-purpose water softeners (agents for preventing precipitation of calcium and magnesium) and their analogous compounds such as nitrilotriacetic acid, diethylenetriaminepentaacetic acid, ethylenediaminetetraacetic acid, N,N,N-trimethylenephosphonic acid, ethylenediamine-N,N,N′,N′-tetramethylenesulfonic acid, transcyclohexanediaminetetraacetic acid, 1,2-diaminopropanetetraacetic acid, glycol ether diamine tetraacetic acid, ethylenediamine-ortho-hydroxyphenylacetic acid, ethylenediaminedisuccinic acid (SS form), N-(2-carboxylate ethyl)-L-aspartic acid, β-alaninediacetic acid, 2-phosphonobutane-1,2,4-tricarboxylic acid, 1-hydroxyethylidene-1,1-diphosphonic acid, N,N′-bis(2-hydroxybenzyl)ethylenediamine-N,N′-diacetic acid and 1,2-dihydroxybenzene-4,6-disulfonic acid. The water softeners may optionally be used in combination of two or more.

The water softener should be incorporated in the polishing slurry of the invention in a sufficient amount to sequester the contaminants including metal ions such as polyvalent metal ions. For example, the water softener content is preferably 0.0003 to 0.07 mol per liter of the polishing slurry at the time of use in polishing.

The polishing slurry of the invention optionally contains any of various solvents. Exemplary solvents that may be used include water and organic solvents such as alcohols (e.g., methanol, ethanol, 1-propanol, 2-propanol, 2-propion-1-ol, allyl alcohol, ethylene cyanohydrin, 1-butanol, 2-butanol, (S)-(+)-2-butanol, 2-methyl-1-propanol, t-butyl alcohol, perfluoro-t-butyl alcohol, t-pentyl alcohol, 1,2-ethanediol, 1,2-propanediol, 1,3-propanediol, 1,3-butanediol, 2,3-butanediol, 1,5-pentanediol, 2-butene-1,4-diol, 2-methyl-2,4-pentanediol, glycerol, 2-ethyl-2-(hydroxymethyl)-1,3-propanediol, 1,2,6-hexanetriol); ethers (e.g., dioxane, trioxane, tetrahydrofuran, diethylene glycol diethyl ether, 2-methoxyethanol, 2-ethoxyethanol, 2,2-(dimethoxy)ethanol, 2-isopropoxyethanol, 2-butoxyethanol, 1-methoxy-2-propanol, 1-ethoxy-2-propanol, furfuryl alcohol, tetrahydrofurfuryl alcohol, ethylene glycol, diethylene glycol, diethylene glycol monomethyl ether, diethylene glycol monoethyl ether, diethylene glycol monobutyl ether, triethylene glycol, triethylene glycol monomethyl ether, tetraethylene glycol, dipropylene glycol, dipropylene glycol monomethyl ether, dipropylene glycol monoethyl ether, tripropylene glycol monomethyl ether, polyethylene glycol, diacetone alcohol, 2-methoxyethyl acetate, 2-ethoxyethyl acetate, diethylene glycol monoethyl ether acetate); and ketones (e.g., acetone, methyl ethyl ketone, acetyl acetone, and cyclohexanone).

Of these solvents, water, methanol, ethanol, 2-propanol, tetrahydrofuran, ethylene glycol, acetone and methyl ethyl ketone are more preferred.

The polishing slurry of the invention is not particularly limited for its production method. For example, the polishing slurry may be produced by thoroughly mixing two colloidal silicas of different association degrees, an anticorrosive, an oxidizer, and optionally used additives, water and any of various organic solvents using an agitator such as a mixer. Exemplary methods that may be used include a method in which the ingredients are mixed after adjusting them to a preset pH and a method in which the ingredients are mixed before adjusting them to a preset pH. Use may also be made of a method in which a concentrate containing the foregoing compound is produced and diluted before use to adjust the concentration to a predetermined value. The concentrate may also be used by adjusting its pH to a preset value after dilution. A preset amount of pure water for dilution may be added to the concentrate. Alternatively, a preset amount of concentrate may be added to pure water for dilution.

The polishing slurry of the invention is usually suitable for use in chemical mechanical polishing of an interlayer dielectric film made of a material having a low dielectric constant and/or a barrier layer which is present between an interconnection made of copper metal and/or a copper alloy and the interlayer dielectric film on a semiconductor integrated circuit substrate (e.g., silicon substrate) and which is made of a metallic barrier material for preventing diffusion of metals such as copper. Usually in the semiconductor device manufacturing process, an interlayer dielectric film with a low dielectric constant is covered with a barrier layer, on which a metal interconnection film is formed by metal plating; the metal interconnection film is then polished with a metal polishing slurry in the chemical mechanical polishing step, which is followed by polishing of the barrier layer and/or the interlayer dielectric film. The polishing slurry of the invention is preferably used in this process. This process preferably includes a rinsing step which is carried out after polishing of the metal interconnection but before polishing of the barrier layer and/or interlayer dielectric film.

[Metallic Barrier Material]

The material making up the barrier layer which is one of the layers to be polished with the polishing slurry of the invention is generally a low-resistance metallic material, and particularly preferred examples thereof include Ti, TiN, TiW, Ta, TaN, W, WN, Ru, Mn and Mn—Cu alloys.

[Interlayer Dielectric Film]

Examples of the interlayer dielectric film which is one of the layers to be polished with the polishing slurry of the invention include commonly used ones made of tetraethoxysilane (TEOS), SiOC and organic-inorganic hybrid materials such as methylsilsesquioxane (MSQ). In particular, the polishing slurry of the invention may be advantageously used in the TEOS film. An example of the method of film formation includes, but is not limited to, plasma-enhanced CVD.

[Metal Wiring Material]

In the practice of the invention, the object to be polished preferably has interconnections made of copper metal and/or a copper alloy as applied to semiconductor devices such as LSI. Copper alloys are particularly preferable starting materials for the interconnections. A copper alloy containing silver is preferably selected from among the copper alloys.

The copper alloy preferably contains silver in an amount of not more than 40 wt %, more preferably not more than 10 wt % and even more preferably not more than 1 wt %. The copper alloy containing silver in an amount of 0.00001 to 0.1 wt % exhibits the most significant effects.

[Width of Interconnections]

When applied to, for example, dynamic random access memory (DRAM) devices, the object to be polished in the invention preferably has interconnections with a half pitch of up to 0.15 μm, more preferably up to 0.10 μm, and even more preferably up to 0.08 μm.

When applied to, for example, microprocessing unit (MPU) devices, the object to be polished preferably has interconnections with a half pitch of up to 0.12 μm, more preferably up to 0.09 μm, and even more preferably up to 0.07 μm.

The polishing slurry of the invention exhibits particularly outstanding effects on those having such interconnections.

[Polishing Method]

The polishing slurry of the invention may be prepared as a concentrate which is diluted with water or an aqueous solution before use to form a working slurry (1); or prepared by furnishing various ingredients in the form of the aqueous solutions described later, mixing the solutions and diluting the mixture with water as needed to thereby form a working slurry (2); or again, prepared as a working slurry itself (3).

Any type of polishing slurry may be applied in the polishing method of the invention.

The polishing method is a method which involves feeding the polishing slurry to a polishing pad on a polishing platen and moving the polishing pad and an object surface to be polished relative to each other with the polishing pad in contact with the object surface.

An ordinary polisher having a holder which holds the object having a surface to be polished (e.g., a wafer having a film of a conductive material formed thereon) and a polishing platen (provided with a motor whose number of revolution is variable or the like) onto which a polishing pad is attached may be used as the apparatus employed for polishing. The polishing pad is not subject to any particular limitation, and may be made of, for example, a common nonwoven fabric, expanded polyurethane, or porous fluorocarbon resin. No particular limitation is imposed on the polishing conditions, although to keep the object from flying off the platen, it is preferable for the rotation speed of the platen to be 200 rpm or less. The pressure with which the object having the surface to be polished (film to be polished) is pressed against the polishing pad is preferably from 0.68 to 34.5 KPa. To achieve satisfactory uniformity of the polishing rate across the object and adequate pattern planarity, a pressure of 3.40 to 20.7 KPa is more preferred.

During polishing, it is preferable to continuously feed the polishing slurry by means of a pump or the like to the polishing pad.

After the end of polishing, the polished object is thoroughly washed with running water, following which water drops adhering to the polished object are dislodged using a spin dryer or the like, and the object is dried.

When a concentrate is diluted in the invention as in the method (1) above, the aqueous solution as described below can be used. The aqueous solution is water in which at least one of a colloidal silica, an anticorrosive, an organic acid, additives and an oxidizer is incorporated in advance, and the sum of the ingredients in the aqueous solution and the ingredients in the concentrate to be diluted makes up the total ingredients of the polishing slurry for use in polishing (working slurry).

When a concentrated slurry is used after dilution with an aqueous solution in this way, difficult-to-dissolve ingredients can be blended later in the form of an aqueous solution, which makes it possible to prepare a slurry that is more highly concentrated.

Methods for diluting a concentrated slurry with water or an aqueous solution include a method in which a line that feeds a concentrated polishing slurry and a line that feeds water or an aqueous solution are joined together at some intermediate point so that the respective fluids may be mixed, with the resulting polishing slurry dilution being fed to the polishing pad as a working slurry. Mixing of the concentrated slurry and the water or aqueous solution may be carried out by conventional methods including a method that involves causing the two fluids to run under pressure through narrow passages so that the fluids may collide and mix with each other; a method in which a material such as glass tubing is packed in a pipe so as to make the flow of liquid split and confluent repeatedly; or a method that provides blades within a pipe which are powered to rotate.

The polishing slurry is preferably fed at a rate of 10 to 1,000 ml/min. To achieve satisfactory uniformity of the polishing rate across the object surface to be polished and adequate pattern planarity, a feed rate of 170 to 800 ml/min is more preferred.

One example of a method in which polishing is carried out while a concentrated slurry is diluted with water or an aqueous solution is a process which independently provides a line that feeds a polishing slurry and a line that feeds water or an aqueous solution, feeds predetermined amounts of fluid from each line to the polishing pad, and carries out mixing of the two fluids and polishing at a time by moving the polishing pad and the surface to be polished relative to each other. In another process which may be used, predetermined amounts of concentrated polishing slurry and of water or an aqueous solution are added to a single vessel and mixed, and the slurry after such mixing is fed to the polishing pad to carry out polishing.

In another polishing method, the ingredients to be contained in the polishing slurry are separated into at least two components. At the time of their use, the two or more components are diluted with water or an aqueous solution and fed to the polishing pad on the polishing platen, and polishing is carried out while moving the surface to be polished and the polishing pad relative to each other with the polishing pad in contact with the surface.

For example, Component (A) containing an oxidizer and Component (B) containing colloidal silicas, an anticorrosive, an organic acid, other additives and water may be prepared in advance and used after dilution with water or an aqueous solution.

In an alternative case, additives having a low solubility are incorporated in both of Components (A) and (B). More specifically, Component (A) containing an oxidizer, additives and a colloidal silica, and Component (B) containing an organic acid, additives, a colloidal silica and water are prepared in advance and used after dilution with water or an aqueous solution.

In the above example, three lines are required to separately feed Component (A), Component (B), and the water or aqueous solution. Mixing for dilution may be carried out by a method in which the three lines are coupled to a single line for feeding to the polishing pad so that mixing is realized in the latter line. In this case, an alternative possibility is to join together two of the three lines, then later join the third line. In this method, the component containing difficult-to-dissolve additives and the other component are initially mixed in a long passage so as to ensure a sufficient dissolution time, following which water or an aqueous solution is added from its feeding line joined downstream of the mixing passage.

Other exemplary mixing methods include, similar to the above, a method where the three lines are each directly brought to the polishing pad and mixing is achieved by the movement of the polishing pad and the surface to be polished relative to each other, and a method where the three components as above are mixed in a single vessel, from which the diluted polishing slurry is fed to the polishing pad.

In the polishing method as described above, an alternative procedure is the one in which one component including the oxidizer is kept at a temperature of up to 40° C. while heating other components to a temperature in a range of room temperature to 100° C., and the temperature is adjusted to not more than 40° C. by the mixing of the one component and other components, or in the subsequent dilution of the mixture with water or an aqueous solution. This method makes use of the increase in solubility at a higher temperature, and is advantageous in order to increase the solubility of low-solubility materials for the polishing slurry.

Because the materials which have been dissolved by warming the other components above to a temperature in a range from room temperature to 100° C. precipitate out of solution when the temperature falls, in cases where the other components are in a low-temperature state at the time of use, the precipitated materials must be dissolved by pre-warming the components. This can be done by employing a means which warms the other components, then delivers the components in which the materials have been dissolved, or a means which agitates then delivers each of the precipitate-containing liquids, and warms the line for feeding the relevant component to enable dissolution. If one component containing the oxidizer is heated to a temperature of 40° C. or more, the other components having been warmed may bring about decomposition of the oxidizer. Therefore, it is preferred for the mixture containing the other components having been warmed and the component containing the oxidizer to have a temperature of not more than 40° C.

In the practice of the invention, the polishing slurry may thus be fed to the surface to be polished in the form of two or more separate components. In such a case, it is preferable to divide the ingredients into an oxidizer-comprising component and an organic acid-comprising component. It is also possible to prepare the polishing slurry as a concentrate and feed it to the surface to be polished separately from the diluting water.

In cases where a method of feeding the polishing slurry separated into two or more components to the surface to be polished is applied in the invention, the amount of the polishing slurry corresponds to the sum of the amounts of feeding from the respective lines.

[Pad]

The polishing pad that may be applied to the polishing method of the invention may be a pad having an unexpanded structure or a pad having an expanded structure. In pads having an unexpanded structure, a hard synthetic resin bulk material such as a plastic plate is used as the pad. There are three general types of pads having an expanded structure: those made of closed-cell foam (dry expanded), those made of open-cell foam (wet expanded), and those made of two-layer composites (laminated). Of these, pads made of two-layer composites (laminated) are especially preferred. Expansion may be uniform or non-uniform.

In addition, the polishing pad may contain an abrasive generally used in polishing (for example, ceria, silica, alumina, or resin). The polishing pad may be of a soft or hard nature. In a laminated polishing pad, it is preferable to have the layers made of materials of different hardnesses. Preferred materials for the polishing pad include nonwoven fabric, synthetic leather, polyamide, polyurethane, polyester and polycarbonate. The surface of the polishing pad which comes into contact with the surface to be polished may be shaped so as to form thereon, for example, grooves arranged as a grid, holes, concentric grooves, or spiral grooves.

[Wafer]

The wafer which is an object to be subjected to CMP with the polishing slurry of the invention (e.g., the silicon wafer) preferably has a diameter of at least 200 mm and more preferably at least 300 mm. The effects of the invention are significantly exhibited at a diameter of at least 300 mm.

[Polishing Apparatus]

The apparatus with which polishing can be carried out using the polishing slurry of the invention is not particularly limited, and examples thereof include Mirra Mesa CMP, Reflexion CMP (Applied Materials, Inc.), FREX200, FREX300 (Ebara Corporation), NPS3301, NPS2301 (Nikon Corporation), A-FP-310A, A-FP-210A (Tokyo Seimitsu Co., Ltd.), 2300 TERES (Lam Research Corporation), and Momentum (SpeedFam-IPEC, Inc.).

### EXAMPLES

The invention is described below in further detail by way of examples. However, the invention should not be construed as being limited to the following examples.

### Example 1

A polishing slurry of the composition indicated below was prepared and a polishing experiment was conducted.

### [Composition (1)]

| | | |
|---|---|---|
| Quaternary ammonium salt: | 0.2 | g/L |
| tetramethylammonium nitrate | | |
| Anticorrosive: benzotriazole (BTA) | 0.3 | g/L |
| First colloidal silica | 25 | g/L |
| (Primary particle size: 35 nm; | | |
| association degree: 1.1; available | | |
| from Fuso Chemical Co., Ltd.) | | |
| Second colloidal silica | 25 | g/L |
| (Primary particle size: 36 nm; | | |
| association degree: 2.1; | | |
| available from Fuso Chemical Co., Ltd.) | | |
| Carboxy group-containing compound: glycolic acid | 1 | g/L |
| pH (adjusted with ammonia water and nitric acid) | 4.0 | |
| Oxidizer: hydrogen peroxide solution | 10 | mL |
| (hydrogen peroxide concentration: 30 wt %) | | |
| Pure water added to a total volume of | 1000 | mL |

[Evaluation Method]

A polishing apparatus LGP-612 manufactured by LapmasterSFT Corp. was used to polish each of the wafer films described below under the following conditions while feeding a slurry.

Table speed: 90 rpm

Head speed: 85 rpm

Polishing pressure: 13.79 kPa

Polishing pad: Polotexpad manufactured by Nitta Corporation

Feed rate of the polishing slurry: 200 ml/min

[Evaluation of Polishing Rate]

The wafer used for evaluating the polishing rate was a 8-inch wafer in which a tetraethoxysilane (TEOS) film to be polished had been deposited on a silicon substrate.

[Polishing Rate]

The thicknesses of the TEOS film before and after CMP under the above conditions were measured, respectively, and the polishing rate was calculated from the following expression:

Polishing rate (nm/min)=(thickness of film to be polished−thickness of polished film)/polishing time

The results obtained are shown in Table 1.

[Evaluation of Number of Scratches Following Polishing]

The TEOS film having been polished by the method as described above was rinsed with pure water and dried, then evaluated for the number of scratches with a size of at least 0.5 μm in a simplified manner using the following inspection apparatus.

Inspection apparatus: Surfscan SP1 manufactured by KLA-Tencor Corporation

### Examples 2 to 7 and Comparative Examples 1 to 7

Composition (1) in Example 1 was replaced by the compositions shown in Table 1 to prepare polishing slurries (adjusted to a total volume of 1000 mL by the addition of pure water), which were used to conduct polishing experiments under the same polishing conditions as in Example 1. The results are shown in Table 1. In Table 1, “Organic acid” indicates a carboxy group-containing compound.

TABLE 1

| | Polishing slurry | | | | | | | Evaluation result | |
|---|---|---|---|---|---|---|---|---|---|
| | First | Second | | | | | 30% | TEOS | |
| | colloidal | colloidal | | Organic | Quaternary ammonium | | hydrogen | polishing | |
| | silica | silica | Anticorrosive | acid | salt | | peroxide | rate | Number of |
| | (Content) | (Content) | (Content) | (Content) | (Content) | pH | (ml/L) | (nm/min) | scratches |
| EX 1 | A-1 | A-2 | BTA | D1 | Tetramethylammonium | 4 | 10 | 120 | 10 |
| | 25 g/L | 25 g/L | (0.3 g/L) | (1 g/L) | nitrate (0.2 g/L) | | | | |
| EX 2 | A-2 | A-3 | DBTA | D2 | Tetramethylammonium | 3.5 | 10 | 125 | 14 |
| | 20 g/L | 30 g/L | (0.3 g/L) | (1 g/L) | nitrate (0.2 g/L) | | | | |
| EX 3 | A-1 | A-3 | DCEBTA | D1 | Tetramethylammonium | 2 | 10 | 110 | 9 |
| | 15 g/L | 15 g/L | (0.3 g/L) | (1 g/L) | nitrate (0.2 g/L) | | | | |
| EX 4 | A-4 | A-5 | HEABTA | D4 | Tetramethylammonium | 3 | 10 | 90 | 11 |
| | 20 g/L | 20 g/L | (0.3 g/L) | (1 g/L) | nitrate (0.2 g/L) | | | | |
| EX 5 | A-5 | A-6 | TTA | D3 | Tetramethylammonium | 2.5 | 10 | 101 | 15 |
| | 20 g/L | 25 g/L | (0.3 g/L) | (1 g/L) | nitrate (0.2 g/L) | | | | |
| EX 6 | A-6 | A-4 | TET | D2 | Tetramethylammonium | 5 | 10 | 110 | 13 |
| | 30 g/L | 20 g/L | (0.3 g/L) | (1 g/L) | nitrate (0.2 g/L) | | | | |
| EX 7 | A-3 | A-7 | AMT | D3 | Tetramethylammonium | 3 | 10 | 99 | 10 |
| | 20 g/L | 25 g/L | (0.3 g/L) | (1 g/L) | nitrate (0.2 g/L) | | | | |
| CE 1 | A-3 | A-4 | TEA | D5 | Tetramethylammonium | 3.5 | 10 | 74 | 15 |
| | 30 g/L | 20 g/L | (0.3 g/L) | — | nitrate (0.2 g/L) | | | | |
| CE 2 | A-1 | A-4 | IMD | D3 | Tetramethylammonium | 3.5 | 10 | 60 | 14 |
| | 25 g/L | 25 g/L | (0.3 g/L) | (1 g/L) | nitrate (0.2 g/L) | | | | |
| CE 3 | A-4 | A-8 | HMBTA | D5 | Tetramethylammonium | 4 | 10 | 55 | 17 |
| | 20 g/L | 30 g/L | (0.3 g/L) | — | nitrate (0.2 g/L) | | | | |
| CE 4 | A-3 | — | HEATTA | D2 | Tetramethylammonium | 5 | 10 | 102 | 45 |
| | 70 g/L | | (0.3 g/L) | (1 g/L) | nitrate (0.2 g/L) | | | | |
| CE 5 | A-3 | — | 123T | D2 | Tetramethylammonium | 5 | 10 | 70 | 18 |
| | 35 g/L | | (0.3 g/L) | (1 g/L) | nitrate (0.2 g/L) | | | | |
| CE 6 | A-6 | — | 124T | D1 | Tetramethylammonium | 3 | 10 | 90 | 50 |
| | 90 g/L | | (0.3 g/L) | (1 g/L) | nitrate (0.2 g/L) | | | | |
| CE 7 | A-6 | — | DCETTA | D3 | Tetramethylammonium | 3 | 10 | 65 | 50 |
| | 40 g/L | | (0.3 g/L) | (1 g/L) | nitrate (0.2 g/L) | | | | |

The compounds abbreviated in Table 1 are shown in detail below.

### [Anticorrosive]

BTA: 1,2,3-benzotriazole
DBTA: 5,6-dimethyl-1,2,3-benzotriazole
DCEBTA: 1-(1,2-dicarboxyethyl)benzotriazole
HEABTA: 1-[N,N-bis(hydroxyethyl)aminomethyl]benzotriazole
HMBTA: 1-(hydroxymethyl)benzotriazole
TTA: tolyltriazole
TET: 1H-tetrazole
AMT: 5-aminotetrazole
TEA: 1H-tetrazole-5-acetic acid
IMD: imidazole
123T: 1,2,3-triazole
124T: 1,2,4-triazole
DCETTA: 1-(1,2-dicarboxyethyl)tolyltriazole
HEATTA: 1-[N,N-bis(hydroxyethyl)aminomethyl]tolyltriazole

Table 2 shows the primary particle size and association degree of the colloidal silicas A-1 to A-8 shown in Table 1.

TABLE 2

| | Primary | |
|---|---|---|
| Type of | particle | Association |
| abrasive | size (nm) | degree |
| A-1 | 35 | 1.1 |
| A-2 | 36 | 2.1 |
| A-3 | 38 | 3.2 |
| A-4 | 25 | 1.2 |
| A-5 | 27 | 2.0 |
| A-6 | 26 | 3.1 |
| A-7 | 38 | 2.4 |
| A-8 | 25 | 1.0 |

Table 3 shows the compound names or D-1 to D-5 indicated in the column of “Organic acid” (carboxy group-containing compound) in Table 1.

TABLE 3

| | Compound name |
|---|---|
| D-1 | Glycolic acid |
| D-2 | 2,5-Furandicarboxylic acid |
| D-3 | 2-Tetrahydrofurancarboxylic acid |
| D-4 | Methoxycarboxylic acid |
| D-5 | No addition of organic acid |

Table 1 reveals that in each of the cases where the polishing slurries in Examples 1 to 7 were used, the TEOS polishing rate was at least 90 nm/min and the number of scratches following polishing was up to 15. On the other hand, in Comparative Examples 1 to 3, the number of scratches following polishing was equivalent to that in each of Examples 1 to 7, but the TEOS polishing rate was 50 to 70 nm/min which is lower than in Examples 1 to 7. It is revealed from the above results that a high polishing rate and a high scratch resistance are more efficiently achieved in cases where two abrasives to be combined have association degrees differing by at least 0.5 and primary particle sizes differing by not more than 5.0 nm.

According to Comparative Examples 4 to 7 using only one abrasive, a higher abrasive concentration is necessary to obtain a higher polishing rate, and the number of scratches is increased with higher abrasive concentration. The polishing rate and the number of scratches in Comparative Examples 4 to 7 could not reach the level of Examples 1 to 7.

What is claims is:

1. A polishing slurry used for chemical mechanical polishing of a barrier layer and an interlayer dielectric film in manufacturing a semiconductor integrated circuit, the polishing slurry comprising:
two colloidal silicas which have association degrees differing from each other by at least 0.5 and primary particle sizes differing from each other by 5.0 nm or less;
an anticorrosive; and
an oxidizer.

2. The polishing slurry of claim 1, wherein the anticorrosive is an aromatic heterocyclic compound selected from the group consisting of imidazoles, triazoles, tetrazoles, and benzotriazoles.

3. The polishing slurry of claim 1 having a pH of 2 to 6.

4. The polishing slurry of claim 1, further comprising a compound having at least one carboxy group in the molecule.

5. The polishing slurry of claim 1, further comprising a quaternary ammonium salt.
